(19) United States
(12) Patent Application Publication
(10) Pub. No.: US 2015/0059192 A1
(43) Pub. Date: Mar. 5, 2015

(54) Power Tool Clamping Device

(71) Applicant: Robert Bosch GmbH, Stuttgart (DE)

(72) Inventor: Giuseppe Fragapane, Solothurn (CH)

(73) Assignee: Robert Bosch GmbH, Stuttgart (DE)

(21) Appl. No.: 14/391,859

(22) PCT Filed: Feb. 20, 2013
(86) PCT No.: PCT/EP2013/053300

§ 371 Date: Oct. 10, 2014

(30) Foreign Application Priority Data
Apr. 13, 2012 (DE) 10 2012 206 036.7

(51) Int. Cl. B23D 51/10

(52) U.S. Cl. CPC B23D 51/10
USPC 30/392; 279/56; 279/47

(57) ABSTRACT

A power tool clamping device comprises at least one clamping unit having at least one movably mounted force-fit clamping plane element and at least one actuating element configured to move the at least one force-fit clamping plane element to clamp a working tool at least in a clamping position. The at least one actuating element is mounted movably relative to the at least one force-fit clamping plane element along at least two at least substantially mutually transverse movement directions of the at least one actuating element.

### PRIOR ART

There are already known power tool clamping devices, in particular oscillation power tool clamping devices, which comprise a clamping unit that has a movably mounted force-fit clamping plane element and has an actuating element provided to move the force-fit clamping plane element for the purpose of clamping a working tool in a clamping position.

### DISCLOSURE OF THE INVENTION

The invention is based on a power tool clamping device, in particular an oscillation power tool clamping device, comprising at least one clamping unit, which has at least one movably mounted force-fit clamping plane element and has at least one actuating element provided to move the force-fit clamping plane element for the purpose of clamping a working tool at least in a clamping position.

It is proposed that the actuating element be mounted so as to be movable relative to the force-fit clamping plane element along at least two at least substantially mutually transverse movement directions of the actuating element. The expression “movably mounted” is intended here to define, in particular, a mounting of an element relative to at least one further element, wherein the element, in particular dissociated from an elastic deformation of the element and dissociated from movement capabilities caused by a bearing clearance, has a capability to move along at least one axis, along a travel distance greater than 1 mm, preferably greater than 10 mm, and particularly preferably greater than 20 mm, and/or has a capability to move about at least one axis, by an angle greater than 10°, preferably greater than 45°, and particularly preferably greater than 60°. A “clamping unit” is to be understood here to mean, in particular, a unit that, by means of a form fit and/or by means of a force fit, secures a working tool for the purpose of performing work on the workpiece, in particular at least partially by means of the force-fit clamping plane element of the clamping unit. The expression “force-fit clamping plane element” is intended here to define, in particular, an element having at least one clamping face, which extends in a plane and which, in particular, is larger than 0.1 cm², preferably larger than 0.5 cm², and particularly preferably larger than 1.5 cm², and which is provided to clamp the working tool, in particular the shank of the working tool, by means of a force-fit connection. In this case, the design of the clamping face of the force-fit clamping plane element is, in particular, different to that of a curved clamping face. The clamping face is thus preferably to be considered as a clamping plane in the mathematical sense, wherein, for every two points located in the clamping plane, a straight line running through these points is also located entirely in the clamping plane. “Provided” is to be understood to mean, in particular, specially designed and/or specially equipped.

The force-fit clamping plane element is preferably realized as a clamping jaw against which the working tool, in particular the shank of the working tool, bears or is pressed as a result of a clamping force when the force-fit clamping plane element, realized as a clamping jaw, is in a clamping position. The term “claming position” is intended here to define, in particular, a position of the force-fit clamping plane element in which the force-fit clamping plane element bears against a counter-clamping face that corresponds to the force-fit clamping plane element, to generate a clamping force. In this case, when the working tool is disposed in the clamping unit, the force-fit clamping plane element preferably bears against the working tool, in particular the shank of the working tool, and thus exerts a clamping force upon the working tool, in particular upon the shank of the working tool, to clamp the working tool. In this case, when the working tool is disposed in the clamping unit, the force-fit clamping plane element preferably bears against an outer face of the working tool, in particular of the shank of the working tool, that is at least substantially parallel to the clamping face of the force-fit clamping plane element and extends in one plane. “Substantially parallel” is to be understood here to mean, in particular, an alignment of a direction relative to a reference direction, in particular in one plane, wherein the direction deviates from the reference direction by, in particular, less than 8°, advantageously less than 5°, and particularly advantageously less than 2°.

The expression “actuating element” is intended here to define, in particular, an element that can be actuated directly by an operator and that is provided to influence and/or alter a process and/or a state of at least one further element that is coupled to the element, as a result of an actuation and/or as a result of an input of parameters. The actuating element is preferably realized as an actuating sleeve. It is also conceivable, however, for the actuating element to be of a different design, considered appropriate by persons skilled in the art, such as, for example, designed as an actuating knob, as an actuating lever, etc. “At least substantially transversely” is to be understood here to mean, in particular, an alignment of a plane and or of a direction, relative to a further plane and/or a further direction, that preferably deviates from a parallel alignment of the plane and/or of the direction, relative to the further plane and/or the further direction. Particularly preferably, the actuating element is mounted so as to be movable relative to the force-fit clamping plane element along at least two at least substantially mutually perpendicular movement directions of the actuating element. The expression “substantially perpendicular” is intended here to define, in particular, an alignment of a direction relative to a reference direction, wherein the direction and the reference direction, in particular as viewed in one plane, enclose an angle of 90° and the angle has a maximum deviation of, in particular, less than 8°, advantageously less than 5°, and particularly advantageously less than 2°. By means of the design of the power tool clamping device according to the invention, it is advantageously possible to achieve a self-locking function of the clamping unit as a result of the actuating element being mounted so as to be movable relative to the force-fit clamping plane element along the at least two at least substantially mutually transverse movement directions of the actuating element, in particular if the course of one of the at least two at least substantially mutually transverse movement directions of the actuating element differs from a clamping and/or release direction of the force-fit clamping plane element. Advantageously, it is thus advantageously possible to prevent unwanted release of the clamping force of the clamping unit, in particular as a result of a strong action of a reaction force during the performance of work on a workpiece by means of the working tool disposed in the clamping unit.

Furthermore, it is proposed that the actuating element comprise at least one threaded region, by means of which the actuating element is mounted so as to be movable relative to the force-fit clamping plane element. The actuating element, in particular during an actuation, thus executes a translational movement, on which a rotational movement is superposed. A “threaded region” is to be understood here to mean, in particular, a region of the actuating element in which at least one thread turn of a thread, in particular of an internal thread, is disposed. The threaded region of the actuating element preferably acts together with a corresponding threaded region of a driving force transmission element of the clamping unit. It is also conceivable, however, for the actuating element to be mounted in a different manner, considered appropriate by persons skilled in the art, so as to be movable relative to the force-fit clamping plane element along the at least substantially mutually transverse movement directions. In this case, for example, it is conceivable for the actuating element to be mounted by means of a cam mechanism etc. so as to be movable relative to the force-fit clamping plane element. Advantageously, a threaded region of the actuating element makes it possible, in an inexpensive and reliable manner, for the actuating element to be mounted so as to be movable along the at least two substantially mutually transverse movement directions of the actuating element. Moreover, implementation of a self-locking function of the clamping unit can be achieved through simple design means.

It is additionally proposed that the clamping unit have at least one positioning element, which has at least one pressing face, extending at least substantially transversely in relation to a clamping face of the force-fit clamping plane element, for acting upon the force-fit clamping plane element. The term “positioning element” is intended here to define, in particular, an element, in particular a movably mounted element, which holds a further movably mounted element, in particular the force-fit clamping plane element, in at least one position by means of an action of force, or as far as possible prevents at least one movement of the further element along at least one direction. The positioning element is mounted, in particular, so as to be translationally movable. It is also conceivable, however, for the positioning element to be mounted so as to be movable along at least two at least substantially mutually transverse directions, in particular if the positioning element is designed so as to be integral with the actuating element. “Integral with” is to be understood to mean, in particular, connected at least in a materially bonded manner, for example by a welding process, an adhesive process, an injection process and/or another process considered appropriate by persons skilled in the art, and/or, advantageously, formed in one piece such as, for example, by being produced from a casting and/or by being produced in a single- or multi-component injection process and, advantageously, from a single blank. Preferably, when the positioning element is in a mounted state, the pressing face is disposed in an inclined manner relative to the clamping face. The pressing face is preferably realized as a wedge face. It is thus possible, by simple design means, to generate a force component along a movement axis of the positioning element, and a further force component, extending at least substantially transversely in relation to the movement axis of the positioning element, for the purpose of positioning the force-fit clamping plane element.

Advantageously, the force-fit clamping plane element has at least one clamping positioning face, which extends at least substantially transversely in relation to the clamping face of the force-fit clamping plane element, and which is realized so as to correspond with the pressing face of the positioning element. Preferably, the clamping positioning face is disposed in an inclined manner relative to the clamping face.

Preferably, the clamping positioning face is realized as a wedge face. Thus, preferably by means of a combined action of the pressing face and the clamping positioning face, a wedge mechanism is realized, which is provided to move the force-fit clamping plane element into a clamping position, via the positioning element, as a result of an actuation of the actuating element. By simple design means, it is possible to achieve a movement of the force-fit clamping plane element that is at least substantially transverse in relation to a movement direction of the positioning element, for the purpose of clamping the working tool.

Moreover, it is proposed that the clamping unit have at least one positioning element disposed so as to be at least rotationally fixed relative to the force-fit clamping plane element. “Disposed so as to be rotationally fixed” is to be understood here to mean, in particular, a disposition of an element, in particular the positioning element, on a further element, in which a rotational movement of the element relative to a further element is prevented, at least as far as possible. The positioning element, preferably by means of a form-fit connection, is disposed so as to be rotationally fixed relative to the force-fit clamping plane element. It is also conceivable, however, for the positioning element to be disposed so as to be rotationally fixed relative to the force-fit clamping plane element by means of a force-fit connection, etc. By simple design means, a translationally movable mounting of the positioning element can be achieved by means of the design according to the invention. Moreover, advantageously, it is possible to achieve guidance of the positioning element by the force-fit clamping plane element, during a movement relative to the force-fit clamping plane element.

Advantageously, the clamping unit has at least one positioning element that is annular in form. It is also conceivable, however, for the positioning element to be of a different design, considered appropriate by persons skilled in the art, such as, for example, a rectangular design. Preferably, the positioning element is realized as an annular clamping disk that, on an inner diameter of the positioning element, as viewed along a movement axis of the positioning element, comprises at least one pressing face that is inclined relative to an outer face of the positioning element. Advantageously, a compact clamping unit can be realized.

Particularly preferably, the clamping unit has at least one positioning element, wherein the actuating element has at least one bearing contact face against which the positioning element bears in at least one state. It is also conceivable, however, for the positioning element to be realized so as to be integral with the actuating element. In this case, the actuating element is preferably movable relative to the positioning element. By simple design means, it is possible to achieve a movement of the positioning element for the purpose of positioning the force-fit clamping plane element as a result of an actuation of the actuating element.

Furthermore, it is proposed that the clamping unit have at least one spring element, which is provided to apply a spring force to the force-fit clamping plane element, at least along a direction at least substantially perpendicular to a clamping face of the force-fit clamping plane element. A “spring element” is to be understood to mean, in particular, a macroscopic element having at least one extent that, in a normal operating state, can be varied elastically by at least 10%, in particular by at least 20%, preferably by at least 30%, and particularly advantageously by at least 50% and that, in particular, generates a counter-force, which is dependent on a variation of the extent and preferably proportional to the variation and which counteracts the variation. An “extent” of an element is to be understood to mean, in particular, a maximum distance of two points of a perpendicular projection of the element on to a plane. A “macroscopic element” is to be understood to mean, in particular, an element having an extent of at least 1 mm, in particular of at least 5 mm, and preferably of at least 10 mm. Preferably, the spring element is realized as a helical spring. It is also conceivable, however, for the spring element to be of a different design, considered appropriate by persons skilled in the art, such as, for example, designed as a volute spring, as a disk spring, as a leg spring, etc. The design according to the invention makes it possible, advantageously, to achieve a resetting of the force-fit clamping plane element after a release of a positioning force of the positioning element, or of the actuating element, as a result of the spring force.

Moreover, it is proposed that the clamping unit have at least one form-fit fixing element, which is provided to engage in the working tool, at least in the clamping position. The form-fit fixing element is preferably realized as a fixing pin. In this case, the form-fit fixing element is preferably disposed in a recess of the force-fit clamping plane element. It is possible, advantageously, to achieve secure fixing, in particular form-fit fixing, of the working tool when the working tool, in particular the shank of the working tool, is disposed in the clamping unit.

The invention is additionally based on a power tool, in particular a portable power tool, that comprises the power tool clamping device according to the invention. A “portable power tool” is to be understood here to mean, in particular, a power tool for performing work on workpieces, that can be transported by an operator without the use of a transport machine. The portable power tool has, in particular, a mass of less than 40 kg, preferably less than 10 kg, and particularly preferably less than 5 kg. Particularly preferably, the portable power tool has at least one oscillation drive unit. The portable power tool is thus preferably realized as a saber saw. It is also conceivable, however, for the portable power tool to be of a different design, considered appropriate by persons skilled in the art, such as, for example, designed as a compass saw, as a plunge cut saw, as hedge shears, as a tiger saw, etc. Advantageously, a high degree of operating comfort can be achieved by means of the design of the power tool according to the invention. Moreover, advantageously, it is possible to ensure guidance that is as far as possible free of play, in particular in the case of work being performed on workpieces, projecting out from a wall or the like, that are to be worked along a plane that is at least substantially flush with a wall surface of the wall. It is thus possible, advantageously, to ensure a precise work result.

The power tool clamping device according to the invention and/or the power tool according to the invention are/is not intended in this case to be limited to the application and embodiment described above. In particular, the power tool clamping device according to the invention and/or the power tool according to the invention may have individual elements, components and units that differ in number from a number stated herein, in order to fulfill a principle of function described herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

In the drawing:

FIG. 1 shows a power tool according to the invention, in a schematic representation,

FIG. 2 shows an exploded representation of a power tool clamping device according to the invention, in a schematic representation,

FIG. 3 shows a sectional view of the power tool clamping device according to the invention, along the line III-III from FIG. 2, in a schematic representation,

FIG. 4 shows a sectional view, similar to FIG. 3, of an alternative power tool clamping device according to the invention, in a schematic representation,

FIG. 5 shows an exploded representation of a further alternative power tool clamping device according to the invention, in a schematic representation,

FIG. 6 shows a sectional view of the further alternative power tool clamping device according to the invention, along the line VI-VI from FIG. 5, in a schematic representation, and

FIG. 7 shows a sectional view, similar to FIG. 6, of a further alternative power tool clamping device according to the invention, in a schematic representation.

### DESCRIPTION OF THE EXEMPLARY EMBODIMENTS

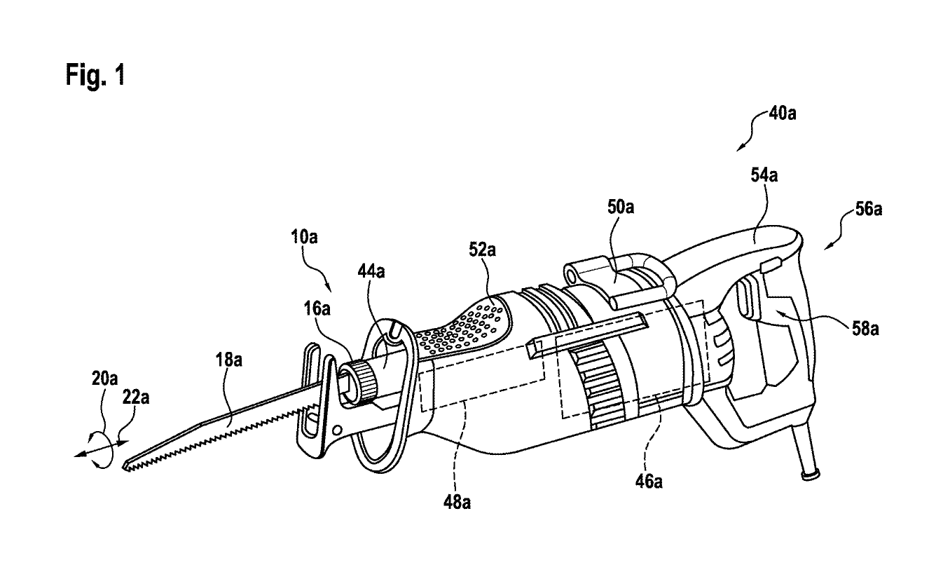

FIG. 1 shows a power tool 40a, realized as a saber saw. The power tool 40a is thus realized as a portable power tool. The power tool 40a in this case comprises a power tool clamping device 10a, for coupling at least one working tool 18a to the power tool 40a. The working tool 18a is realized as a saw blade. In this case, the working tool 18a comprises a shank 42a, by which the working tool 18a can be inserted, at least partially, into a clamping unit 12a of the power tool clamping device 10a. The clamping unit 12a in this case has a driving force transmission element 44a, which is provided to transmit to the working tool 18a a driving force generated by means of the power tool 40a, when the working tool 18a is clamped in the clamping unit 12a. The driving force transmission element 44a is realized as a lift rod.

For the purpose of generating a driving force, the power tool 40a comprises a drive unit 46a and an output unit 48a. The drive unit 46a and the output unit 48a are provided to drive the working tool 18a translationally, for the purpose of performing work on a workpiece (not represented in greater detail here) by means of the power tool 40a, when the working tool 18a is clamped and fixed in the power tool clamping device 10a. The power tool 40a additionally has at least one drive housing 50a and an output housing 52a. The drive housing 50a is provided to carry the drive unit 46a. The output housing 52a is provided to carry the output unit 48a. In addition, the power tool 40a has a handle housing 54a, which is disposed on the drive housing 50a by means of a form-fit and/or force-fit connection. The power tool 40a in this case may comprise a damping unit (not represented in greater detail here), which is provided to isolate the handle housing 54a from the drive housing 50a, as far as possible, in respect of vibration. The handle housing 54a in this case comprises a D-shaped grip region 56a, on which a switching unit 58a is disposed, at least partially, for deactivating the power tool 40a and/or putting it into operation. In addition, the handle housing 54a is of a shell type of construction. It is also conceivable, however, for the handle housing 54a to be of a different design, considered appropriate by persons skilled in the art, such as, for example, a pot type of construction, or a combination of a shell type and pot type of construction.

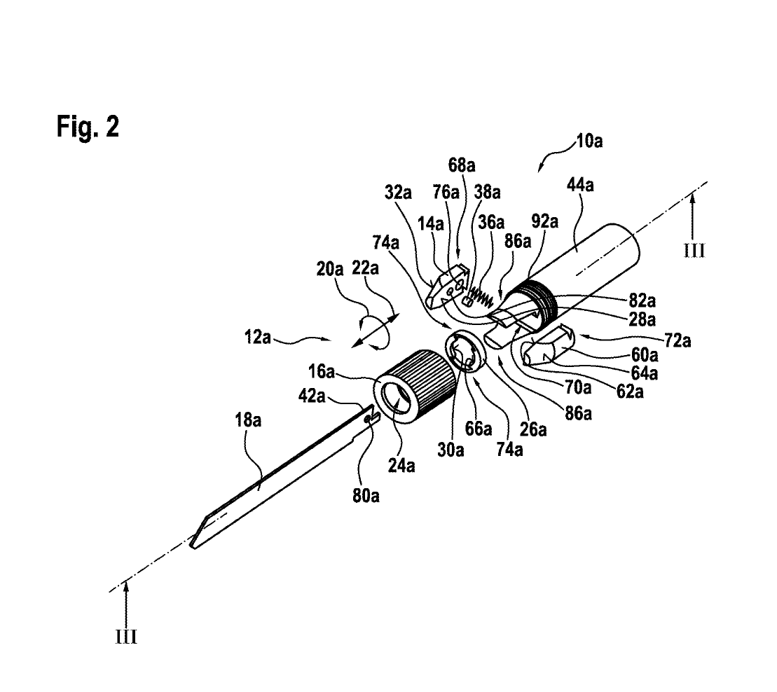

FIG. 2 shows an exploded representation of the power tool clamping device 10a when demounted from the power tool 40a. The power tool clamping device 10a comprises the clamping unit 12a, which has at least one movably mounted force-fit clamping plane element 14a, and at least one actuating element 16a, which is provided to move the force-fit clamping plane element 14a at least into a clamping position for the purpose of clamping the working tool 18a. The actuating element 16a, when in a mounted state, is mounted so as to be movable relative to the force-fit clamping plane element 14a along at least two at least substantially mutually transverse movement directions 20a, 22a of the actuating element 16a. For this purpose, the actuating element 16a comprises at least one threaded region 24a, by means of which the actuating element 16a is mounted so as to be movable relative to the force-fit clamping plane element 14a. The threaded region 24a is constituted by an internal thread of the actuating element 16a. The driving force transmission element 44a in this case has, on a region facing toward the actuating element 16a, an external thread 92a realized so as to correspond with the threaded region 24a. The actuating element 16a is mounted so as to be movable, relative to the force-fit clamping plane element 14a, translationally along a movement axis of the actuating element 16a and rotationally about the movement axis, by means of a combined action of the threaded region 24a of the actuating element 16a and of the external thread 92a of the driving force transmission element 44a. During an actuation, the actuating element 16a thereby executes a translational movement, on which a rotational movement is superposed. Thus, during an actuation, the actuating element 16a executes a screwing motion relative to the force-fit clamping plane element 14a.

Furthermore, the clamping unit 12a has at least one positioning element 26a, which has at least one pressing face 30a, extending at least substantially transversely in relation to a clamping face 28a of the force-fit clamping plane element 14a, for the purpose of acting upon the force-fit clamping plane element 14a. The force-fit clamping plane element 14a in this case likewise has at least one clamping positioning face 32a, which extends at least substantially transversely in relation to the clamping face 28a of the force-fit clamping plane element 14a, and which is realized so as to correspond with the pressing face 30a of the positioning element 26a. The clamping positioning face 32a is disposed on a side of the force-fit clamping plane element 14a that faces away from the clamping face 28a. The pressing face 30a and the clamping positioning face 32a of the force-fit clamping plane element 14a together form a wedge mechanism, by means of which the force-fit clamping plane element 14a can be moved in a direction at least substantially perpendicular to the clamping face 28a, as a result of movement of the positioning element 26a that is at least substantially parallel to the clamping face 28a. The pressing face 30a is thus realized as a wedge face. The clamping positioning face 32a is realized as a corresponding wedge face. The positioning element 26a is translationally movable relative to the force-fit clamping plane element 14a as the result of an actuation of the actuating element 16a along the at least substantially parallel to the clamping face 28a of the force-fit clamping plane element 14a. The actuating element 16a in this case has at least one bearing contact face 34a, against which the positioning element 26a bears in at least one state. Thus, as soon as the actuating element 16a is actuated, the positioning element 26a is moved translationally by means of the actuating element 16a, as a result of bearing against the bearing contact face 34a.

The clamping unit 12a additionally has a further force-fit clamping plane element 60a, which is of a design at least substantially similar to that of the force-fit clamping plane element 14a. The further force-fit clamping plane element 60a thus has a further clamping face 62a and a further clamping positioning face 64a. The further clamping face 62a is provided to clamp the working tool 18a in a force-fit manner by means of a combined action with the clamping face 28a of the force-fit clamping plane element 14a. For this purpose, the force-fit clamping plane element 14a and the further force-fit clamping plane element 60a are moved toward each other, along a direction substantially perpendicular to the clamping face 28a and to the further clamping face 62a, by a translational movement of the positioning element 26a along a direction at least substantially parallel to the clamping face 28a. In this case, the clamping positioning face 32a slides on the pressing face 30a, and the further clamping positioning face 64a slides on a further pressing face 66a of the positioning element 26a. The pressing face 30a and the further pressing face 66a of the positioning element 26a are disposed on the positioning element 26a in an offset manner relative to each other, as viewed along a circumferential direction of the positioning element 26a extending in a plane that is at least substantially perpendicular to the clamping face 28a. In this case, the pressing face 30a, the further pressing face 66a, the clamping positioning face 32a and the further clamping positioning face 64a may be provided with a coating that reduces friction.

In order to prevent, as far as possible, a rotational movement of the positioning element 26a relative to the force-fit clamping plane element 14a and relative to the further force-fit clamping plane element 60a as a result of a rotational movement of the actuating element 16a for the purpose of moving the force-fit clamping plane element 14a and the further force-fit clamping plane element 60a, the positioning element 26a is disposed so as to be at least rotationally fixed relative to the force-fit clamping plane element 14a. For this purpose, the positioning element 26a has form-fit regions 74a, which are realized so as to correspond with rotational fixing regions 86a of the driving force transmission element 44a, and which are provided to produce a form fit between the positioning element 26a and the rotational fixing regions 86a of the driving force transmission element 44a, along a direction of rotation of the actuating element 16a. The positioning element 26a is thus likewise disposed in a rotationally fixed manner relative to the further force-fit clamping plane element 60a. The positioning element 26a is annular in form. The positioning element 26a thus encompasses the force-fit clamping plane element 14a and the further force-fit clamping plane element 60a along the direction of rotation of the actuating element 16a.

The force-fit clamping plane element 14a is mounted in the driving force transmission element 44a so as to be translationally movable along the direction that is at least substantially perpendicular to the clamping face 28a. The force-fit clamping plane element 14a in this case has at least one guide region 68a. The guide region 68a is realized so as to correspond with a guide receiving region 70a of the driving force transmission element 44a. The guide region 68a and the guide receiving region 70a together form a dovetail guide. It is also conceivable, however, for the guide region 68a and the guide receiving region 70a together to form a guide of a different design, considered appropriate by persons skilled in the art, such as, for example, a profile rail guide, a cage rail guide, a telescopic rail guide, etc. Moreover, the further force-fit clamping plane element 60a is mounted in the driving force transmission element 44a so as to be translationally movable along a at least substantially perpendicular to the further clamping face 62a. For this purpose, the further force-fit clamping plane element 60a likewise has a guide region 72a realized so as to correspond with the guide receiving region 70a of the driving force transmission element 44a.

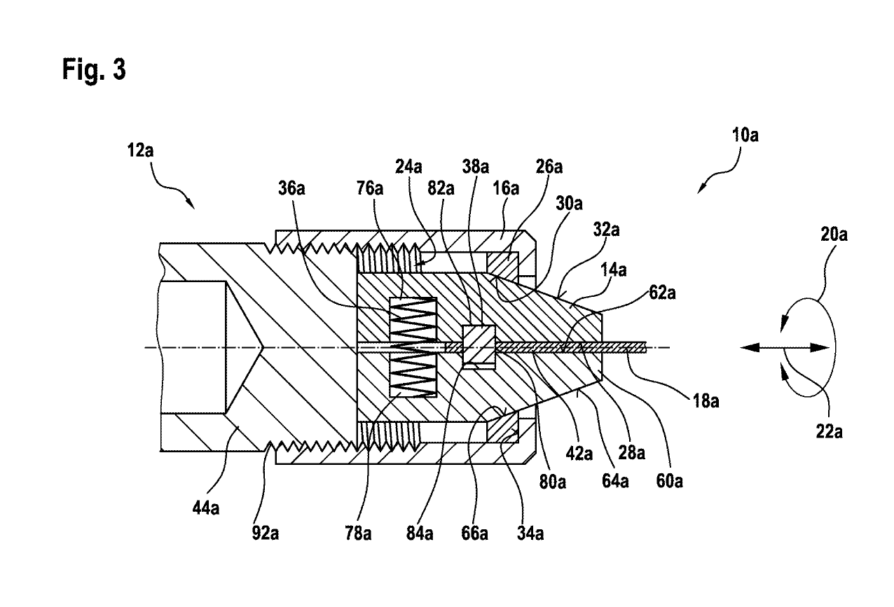

Furthermore, the clamping unit 12a has at least one spring element 36a, which is provided to apply a spring force to the force-fit clamping plane element 14a, at least along the direction that is at least substantially perpendicular to the clamping face 28a of the force-fit clamping plane element 14a. The force-fit clamping plane element 14a in this case has a spring element receiving recess 76a, in which the spring element 36a is disposed, at least partially, when in a mounted state. Moreover, the further force-fit clamping plane element 60a has a further spring element receiving recess 78a, in which the spring element 36a is disposed, at least partially, when in a mounted state (FIG. 3). Thus, the spring element 36a is supported by one end on the force-fit clamping plane element 14a and, by a further end, the spring element 36a is supported on the further force-fit clamping plane element 60a. The spring element 36a is provided to move the force-fit clamping plane element 14a and the further force-fit clamping plane element 60a n opposite directions upon release of a clamping force as a result of an actuation of the actuating element 16a.

In addition, the clamping unit 12a has at least one form-fit fixing element 38a, which is provided to engage in the working tool 18a, at least in the clamping position. The working tool 18a in this case has a form-fit recess 80a, in which the form-fit fixing element 38a engages in the working tool 18a, at least in the clamping position. The form-fit fixing element 38a is realized as a fixing pin. In this case, the form-fit fixing element 38a is fixed in a force-fitting manner, by means of a press fit, in a fixing recess 82a of the force-fit clamping plane element 14a. The form-fit fixing element 38a, when in a mounted state, extends at least substantially perpendicularly in relation to the clamping face 28a of the force-fit clamping plane element 14a, beyond the clamping face 28a (FIG. 3). The further force-fit clamping plane element 60a in this case has a receiving recess 84a, which is provided to receive the form-fit fixing element 38a, at least partially, at least in the clamping position, as a result of engaging in the working tool 18a.

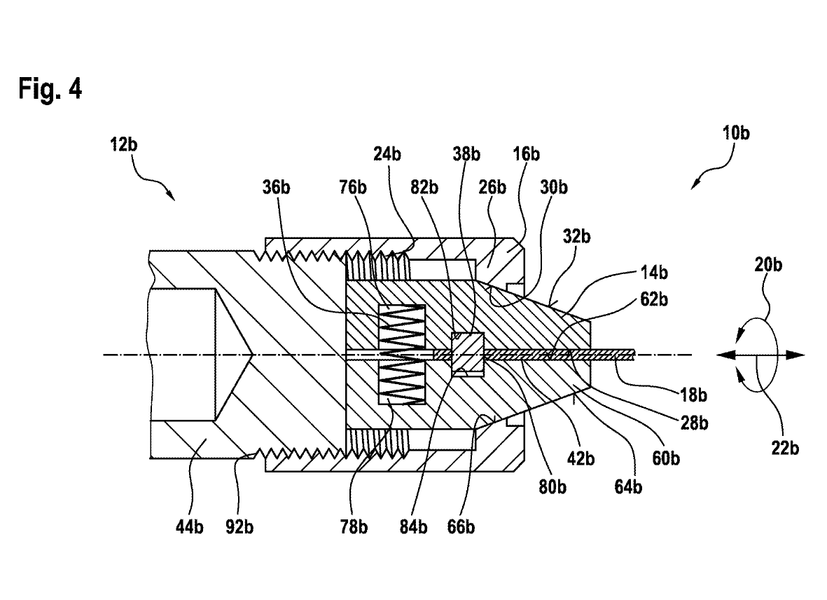

Alternative exemplary embodiments are represented in FIGS. 4 to 7. Components, features and functions that remain substantially the same are basically denoted by the same references. To differentiate the exemplary embodiments, the letters a to d have been appended to the references of the exemplary embodiments. The description that follows is limited basically to the differences in relation to the first exemplary embodiment in FIGS. 1 to 3, and reference may be made to the description of the first exemplary embodiment in FIGS. 1 to 3 in respect of components, features and functions that remain the same.

FIG. 4 shows a sectional view, similar to that of FIG. 3, of an alternative power tool clamping device 10b. The power tool clamping device 10b comprises at least one clamping unit 12b, which has at least one movably mounted force-fit clamping plane element 14b, and has at least one actuating element 16b, which is provided to move the force-fit clamping plane element 14b at least into a clamping position for the purpose of clamping the working tool 18b. The actuating element 16b is mounted so as to be movable relative to the force-fit clamping plane element 14b along at least two at least substantially mutually transverse movement directions 20b, 22b of the actuating element 16b. Furthermore, the clamping unit 12b comprises a positioning element 26b, which is realized so as to be integral with the actuating element 16b. Reference may be made to the clamping unit 12a described in FIGS. 1 to 3 in respect of further features and functions of the clamping unit 12b.

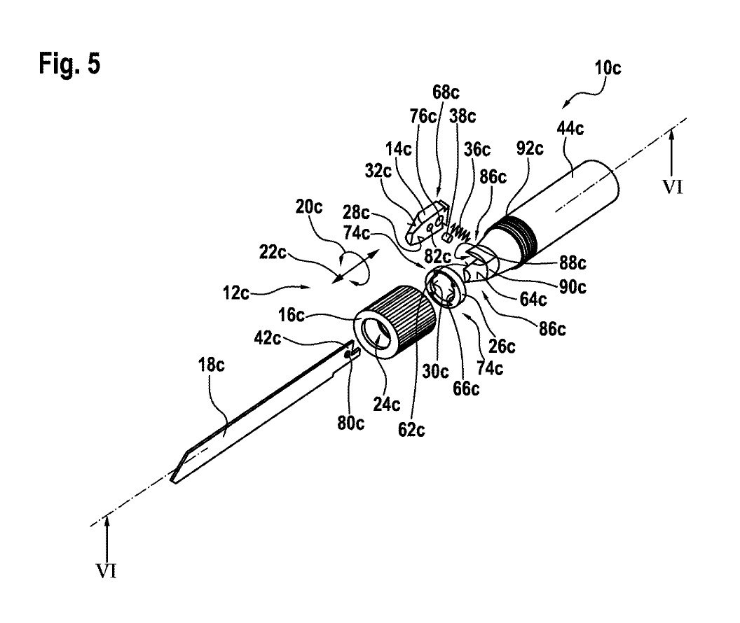

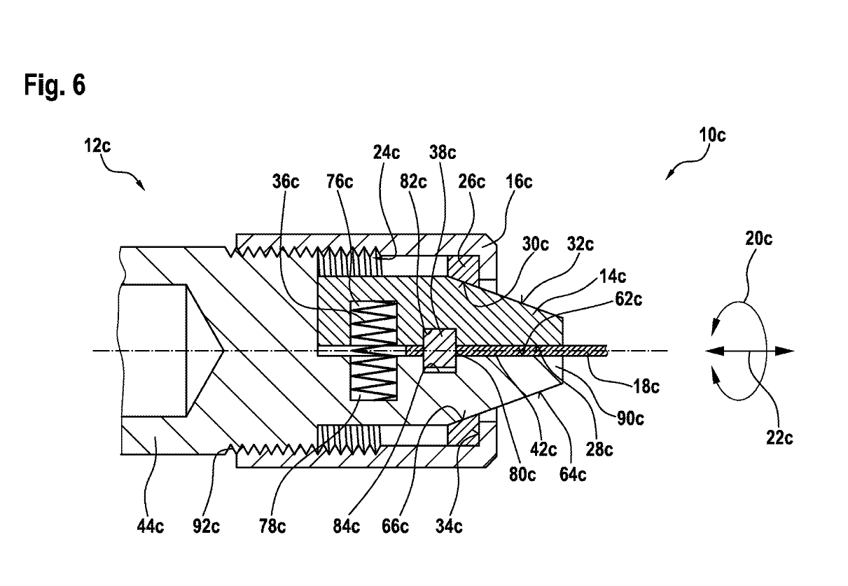

FIG. 5 shows an exploded representation of the power tool clamping device 10c when demounted from a power tool (not represented in greater detail here). The power tool clamping device 10c comprises the clamping unit 12c, which has at least one movably mounted force-fit clamping plane element 14c, and at least one actuating element 16c, which is provided to move the force-fit clamping plane element 14c at least into a clamping position for the purpose of clamping the working tool 18c. The actuating element 16c, when in a mounted state, is mounted so as to be movable relative to the force-fit clamping plane element 14c along at least two at least substantially mutually transverse movement directions 20c, 22c of the actuating element 16c. The force-fit clamping plane element 14c is mounted in a bearing recess 88c of a driving force transmission element 44c of the clamping unit 12c so as to be translational along a substantially perpendicular to a clamping face 28c of the force-fit clamping plane element 14c. The force-fit clamping plane element 14c in this case has at least one guide region 68c. The guide region 68c is realized so as to correspond with a guide receiving region 70c of the driving force transmission element 44c. The guide region 68c and the guide receiving region 70c together form a dovetail guide. It is also conceivable, however, for the guide region 68c and the guide receiving region 70c together to form a guide of a different design, considered appropriate by persons skilled in the art, such as, for example, a profile rail guide, a cage rail guide, a telescopic rail guide, etc. Thus, a force-fit clamping plane element 90c of the driving force transmission element 44c constitutes a further clamping face 62c, which enables the working tool 18c disposed in the clamping unit 12c to be clamped in a force-fitting manner by means of a combined action with the clamping face 28c of the force-fit clamping plane element 14c (FIG. 6). Reference may be made to the clamping unit 12a described in FIGS. 1 to 3 in respect of further features and functions of the clamping unit 12c.

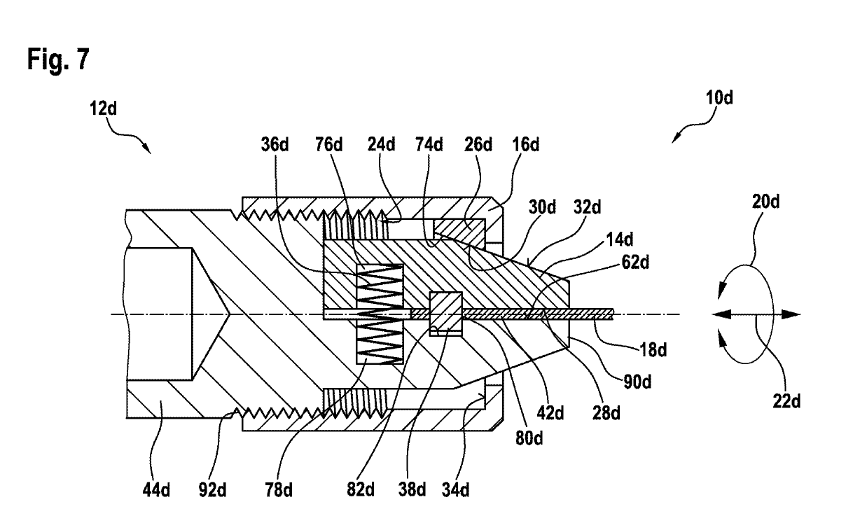

FIG. 7 shows a sectional view, similar to that of FIG. 3, of a further alternative power tool clamping device 10d. The power tool clamping device 10d comprises at least one clamping unit 12d, which has at least one movably mounted force-fit clamping plane element 14d, and has at least one actuating element 16d, which is provided to move the force-fit clamping plane element 14d at least into a clamping position for the purpose of clamping the working tool 18d. The actuating element 16d is mounted so as to be movable relative to the force-fit clamping plane element 14d along at least two at least substantially mutually transverse movement directions 20d, 22d of the actuating element 16d. The force-fit clamping plane element 14d is mounted in a bearing recess 88d of a driving force transmission element 44d of the clamping unit 12d so as to be translational along an at least substantially perpendicular to a clamping face 28d of the force-fit clamping plane element 14d. In respect of a disposition of the force-fit clamping plane element 14d, reference may thus be made to a disposition of the force-fit clamping plane element 14c in FIGS. 5 and 6 and to a design of the driving force transmission element 44d described in FIGS. 5 and 6.

Furthermore, the clamping unit 12d comprises at least one positioning element 26d, which is disposed so as to be rotationally fixed relative to the force-fit clamping plane element 14d. For this purpose, the positioning element 26d has form-fit regions 74d, which are realized so as to correspond with an outer form of the to the force-fit clamping plane element 14d or to correspond with a rotational fixing region (not represented in greater detail here) of the driving force transmission element 44d, and which are provided to produce a form fit between the positioning element 26d and the force-fit clamping plane element 14d, along a direction of rotation of the actuating element 16d. The positioning element 26d in this case is of an at least substantially square design. Reference may be made to the clamping unit 12a described in FIGS. 1 to 3 in respect of further features and functions of the clamping unit 12d.

1. A power tool clamping device, comprising:
at least one clamping unit having at least one movably mounted force-fit clamping plane element and at least one actuating element configured to move the at least one force-fit clamping plane element to clamp a working tool at least in a clamping position,
wherein the at least one actuating element is mounted movably relative to the at least one force-fit clamping plane element along at least two at least substantially mutually transverse movement directions of the at least one actuating element.

2. The power tool clamping device as claimed in claim 1, wherein:
the at least one actuating element includes at least one threaded region; and
the at least one actuating element is mounted with the at least one threaded region so as to be movable relative to the at least one force-fit clamping plane element.

3. The power tool clamping device as claimed in claim 1, wherein the at least one clamping unit includes at least one positioning element having at least one pressing face, the at least one positioning element extending at least substantially transversely in relation to a clamping face of the at least one force-fit clamping plane element and configured to act upon the at least one force-fit clamping plane element.

4. The power tool clamping device as claimed in claim 3, wherein the at least one force-fit clamping plane element has at least one clamping positioning face extending at least substantially transversely in relation to the clamping face of the at least one force-fit clamping plane element and configured to correspond with the at least one pressing face of the at least one positioning element.

5. The power tool clamping device as claimed in claim 1, wherein the at least one clamping unit has at least one positioning element rotationally fixed relative to the at least one force-fit clamping plane element.

6. The power tool clamping device as claimed in claim 1, wherein the at least one clamping unit has at least one annular positioning element.

7. The power tool clamping device as claimed in claim 1, wherein:
the at least one clamping unit includes at least one positioning element; and
the at least one actuating element includes at least one bearing contact face against which the positioning element is configured to bear.

8. The power tool clamping device as claimed in claim 1, wherein the at least one clamping unit includes at least one spring element configured to apply a spring force to the at least one force-fit clamping plane element, at least along a direction at least substantially perpendicular to a clamping face of the at least one force-fit clamping plane element.

9. The power tool clamping device as claimed in claim 1, wherein the at least one clamping unit includes at least one form-fit fixing element configured to engage the working tool, at least in the clamping position.

10. A power tool clamping system, comprising:
at least one power tool; and
at least one power tool clamping device including at least one clamping unit having at least one movably mounted force-fit clamping plane element and at least one actuating element configured to move the at least one force-fit clamping plane element to clamp the power tool at least in a clamping position,
wherein the at least one actuating element is mounted movably relative to the at least one force-fit clamping plane element along at least two at least substantially mutually transverse movement directions of the at least one actuating element.

11. The power tool system of claim 10, wherein the at least one power tool is at least one saber saw.

12. The power tool clamping device of claim 1, wherein the power tool clamping device is an oscillation power tool clamping device.
